(19) United States
(12) Patent Application Publication
(10) Pub. No.: US 2004/0238055 A1
(43) Pub. Date: Dec. 2, 2004

(54) Apparatus for fluid transportation

(76) Inventor: Martin John Gardner Doig, Aberdeen (GB)

Correspondence Address: JACOBSON HOLMAN PLLC, 400 SEVENTH STREET N.W., SUITE 600, WASHINGTON, DC, 20004, US

(21) Appl. No.: 10/482,228

(22) PCT Filed: Jun. 28, 2002
(86) PCT No.: PCT/GB02/03025

(30) Foreign Application Priority Data
Jun. 28, 2001 (GB) 0115834.4

(51) Int. Cl. F15D 1/00

(52) U.S. Cl. 138/37; 138/39

(57) ABSTRACT

Apparatus used for the transport of fluids, the apparatus being suitable for use in oil-well production pipelines and pipelines and pipelines connectors used in oil fields or other applications where fluid contains a solid or where a solid is readily precipitated from the fluid. The apparatus comprises a conduit provided with at least one circumferentially discontinuous profiled turbulence inducing means formed around an inner diameter surface of the conduit. The turbulence inducing means may be formed integrally with the inner diameter surface of the conduit. The invention creates turbulent flow thereby preventing the build up of blockages in the conduit which can occur if solid masses form in the conduit.

The present invention relates to components used for the transport of fluids and, more specifically, to components such as oil-well production pipelines and pipeline connectors used in oil fields.

The transmission of oil-field fluids is undertaken through conduits such as pipelines and liners. By the very nature of the origin of these fluids, they can also carry solids in various forms which can be suspended in the fluids or easily precipitated from the fluids. Over a period of time, the solids will be deposited on to the internal bore of the pipe-work where they will adhere to this surface. The resulting effect, known as waxing or scaling, can reduce production rates, ultimately reducing productivity.

Furthermore, such pipe-work and the connectors that are used to conjoin them are slick or smooth in internal profile. As the fluid passing through the pipes travels at specific speeds, the lack of turbulence in the flow regime of the fluid encourages the deposition of solids. Such a lack of turbulence is maintained and assisted by the smooth profile on the internal diameter.

A number of prior art documents have been identified including GB2127581A, WO95/18923A1, WO92/19898A1, U.S. Pat. No. 4,487,510, U.S. Pat. No. 3,835,015 and GB1375908. All of these documents disclose devices which encourage turbulent flow in a conduit by placing a physical obstruction of some kind in the flow path of the conduit. However, where it is necessary to provide a substantially clear path through the conduit to allow the transport or deployment of solid objects such as probes, pigs or cable, any structure which even partially blocks the conduit will impede the transport or deployment of these objects and cannot be used.

It is therefore an object of the present invention to address the problems outlined above whilst maintaining the productivity rates of the pipeline or whichever type of pipe-work is being used.

It is further an object of the present invention to enable prevention of the build-up of solids on the internal bore surface of the pipe-work without having to close down the pipe-line or add further pieces of apparatus to the pipe-work.

Furthermore, it is independently an object of the present invention to improve upon existing types of apparatus used for the prevention and removal of solids build-up from the internal surface of pipe-work in terms of the production time lost by having to close off the pipe-work to enable cleaning apparatus to be inserted, the time, cost and effort involved in this, the cost of the cleaning apparatus itself and the associated risks with inserting apparatus into pipe-work.

According to the present invention, there is provided a conduit member for use in the transportation of fluids, wherein said conduit is provided with at least one circumferentially discontinuous profiled turbulence inducing means formed in a fluid contacting inner diameter surface of the conduit.

Preferably, the profiled turbulence reducing means are formed integrally with the fluid contacting inner surface of the conduit.

Preferably, the conduit is provided with a recess to accommodate an insert shaped to fit the inner diameter surface of the conduit and forming the fluid contacting inner surface of the conduit, said insert being provided with a plurality of circumferentially discontinuous profiled turbulence inducing means formed integrally therewith.

Preferably, the conduit is provided with a recess to accommodate an insert shaped to fit the inner diameter surface of the conduit and forming the fluid contacting inner surface of the conduit, said insert being provided with a plurality of circumferentially discontinuous profiled turbulence inducing means formed integrally therewith.

Preferably, said profiled turbulence inducing means may be provided by at least one indentation. Preferably, a plurality of indentations are arranged at a variety of angles to an axis to the conduit. Optionally, said profiled turbulence inducing means may be provided by at least one blade formed in the indentation. Optionally, said means may be a combination of indentations and blades.

Preferably, said profile may be curved or angular. Optionally, said profile may be shaped to suit the inner diameter and an internal flow regime.

Preferably, said means may be self-cleaning.

Preferably, said means may be arranged radially, longitudinally or randomly to suit the flow regime anticipated. Optionally, means may be arranged helically. In such circumstances the helix is not continuous.

Preferably, said curved profile may be shaped generally in the form of an aerofoil, which will vary according to anticipated flow regime. Preferably, said profile may be provided with a leading edge and a trailing edge. Preferably, said indentations may be arranged at a variety of angles to an axis normal to the longitudinal axis of said conduit. Preferably, said indentations may be arranged so that the fluid is deflected at an angle normal to an impact surface of said profile, the impact surface may be convex or concave.

Preferably, said conduit may be a pipe connector. Optionally, said conduit may be a pin or a box connector. Optionally, said conduit may be an insert. Said connector may be provided with a threaded portion at either end. The threaded portions may be separated by said inner diameter surface. The tubular member may be provided with a recess to accommodate a suitably sized insert. Said threaded portions may be separated by an insert. Said insert may be provided with said inner diameter surface. Said insert may be provided with said turbulence inducing means.

The conduit may be provided with a male threaded portion on at least one end. The pipe may be provided with a male threaded portion at either end of said pipe. The pipe may be provided with a female threaded portion at one end and a male threaded portion at the other end. The male threaded portion is provided with said inner diameter surface. The male threaded portion surrounds said inner diameter surface.

### BRIEF DESCRIPTION OF THE DRAWINGS

Embodiments of the invention will now be described, by way of example only, by reference to the accompanying drawings, in which:

FIG. 1 shows a cross-sectional view of a tubular member in accordance with an embodiment of the present invention;

FIG. 2 shows a cross-sectional view of a tubular member in accordance with a further embodiment of the present invention;

FIG. 3 shows a cross-sectional view of a tubular member provided with an insert in accordance with yet a further embodiment of the present invention; and

FIGS. 4a and 4b are cross sectional views of indentations in a pipe and FIG. 4c is a plan view of the indentation; and

FIG. 5 is a cross sectional view of a further embodiment of the present invention.

### DETAILED DESCRIPTION OF THE EMBODIMENTS

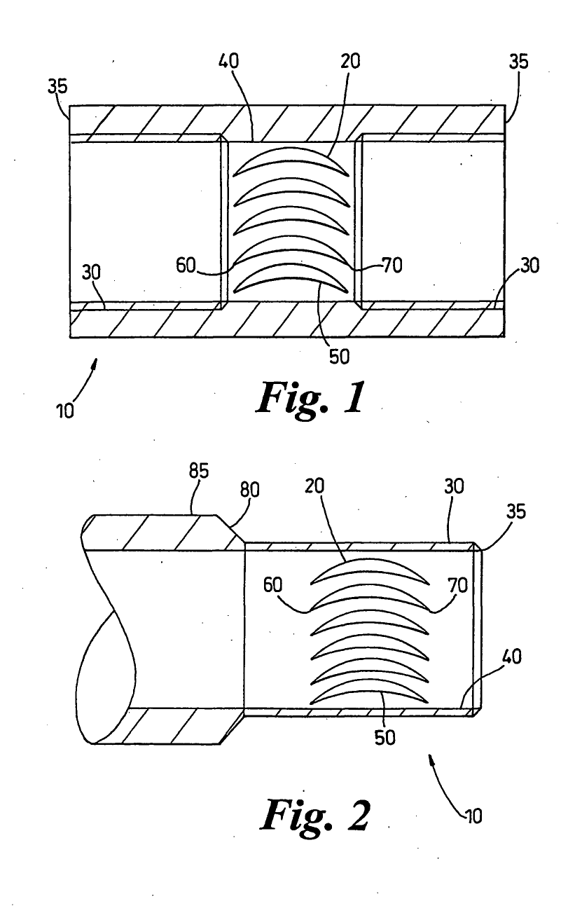

Referring to FIG. 1 of the drawings, there is shown the general arrangement of a conduit, in this case a hollow pipe connector 10 having a through bore 40 which extends longitudinally through the connector and defines an internal diameter surface of the connector. In this embodiment, the pipe connector 10 has a female threaded portion 30 provided at either end of the through bore. Each of the internally threaded portions 30 extend inwardly from the end face 35 at either side of the connector and continue towards the middle of the connector 10 along a portion of the connector bore 40. However, the threaded portions do not meet in the middle of the connector and are separated by a portion of the inner bore diameter surface 40.

This bore surface 40 is the fluid contacting inner surface and has one or more series of profiles 20, dependant upon the anticipated flow regime, cast or machined into the bore surface 40 at regular intervals. In an alternative embodiment the profiles are randomly around the circumference of the inner bore surface 40. In this example, the profiles 20 are shaped in the general form of an aerofoil and are formed parallel with the longitudinal axis of the bore. However, the profiles may be arranged angled, staggered or helical.

Referring now to FIG. 2 of the drawings, there is shown a tubular member 10, which, in this embodiment, is a conduit having an outer diameter 85 and an external threaded portion. The conduit 10 shares many of the same features as the pipe connector shown in FIG. 1 and the same reference numerals will be used for these. The threaded portion in this embodiment is an external thread formed on a diameter of a size suitable for mating with another pipe or connector. This outer diameter of the threaded portion 30 is terminated by a chamfered shoulder 80, which is formed on the outer diameter 85 of the conduit. The outer diameter 85 is larger in size than the diameter of the threaded portion

This threaded portion 30 extends from the end face 35 of the conduit along a portion of the conduit 10 for a length suitable for connection to a pipe connector similar to that shown on FIG. 1. The profiles are formed in the same manner as described previously. Furthermore, the profiles are positioned in that portion of the internal diameter of the conduit that is surrounded by the threaded portion 30 on the external diameter. This positioning of the profiles 20 alters the flow of the fluid upon entry into the conduit.

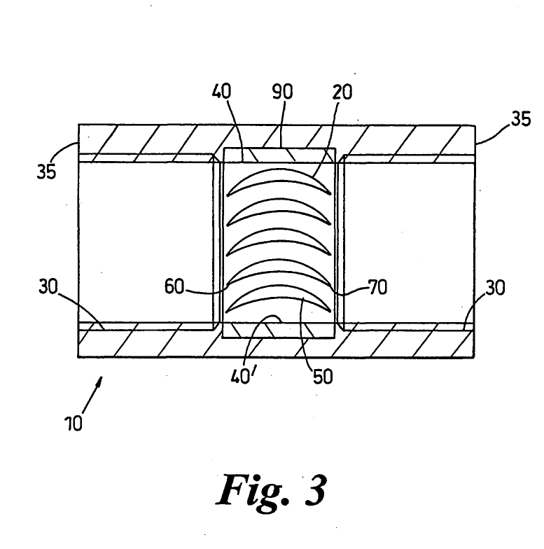

FIG. 3 of the drawings shows another embodiment wherein the tubular member 10 is provided with an insert 90 in the form of a snap-ring which fits into a pre-formed recess in the internal bore of the body 10. The snap-ring is provided with an internal bore 40′ which provides a fluid contacting inner surface. Furthermore, the ring is provided with the turbulence inducing means 20. It is important to note that the internal diameter 40′ of the insert should not project into the main bore 40 of the tubular member as this creates restricted access to the inner diameter for cleaning tools and the like. The snap ring embodiment described herein is applicable to the embodiments of both FIGS. 1 and 2.

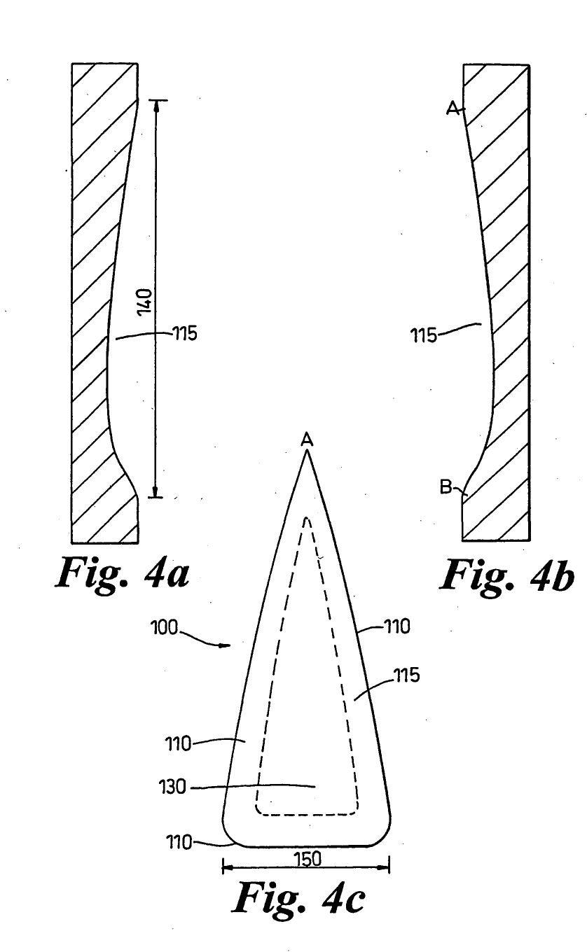

FIGS. 4a, 4b and 4c show an example of a suitable indentation 100 that can be provided in the fluid contacting inner surface of a conduit. FIGS. 4a and 4b show the cross section of a conduit containing the indentation. FIG. 4c is a plan view of the indentation which is substantially triangular in shape. As is apparent, the indentation is substantially triangular and has a curved inner surface 115 that is substantially concave in shape such that the edges 110 of the indentation are at the normal circumference of the conduit, whereas the indentation is further from the centre of the conduit. The overall dimensions are illustrated by reference numerals 140 and 150, the indentation can be sized appropriately depending upon pipe size, fluid flow and other parameters. The maximum depth 130 of the indentation 100 is located towards the base of the indentation 100 towards ‘B’. The depth decreases towards ‘A’. It is also apparent in this example that the edges 110 of the indentation are substantially straight or angular.

The indentation 100 can be located on the fluid contacting inner surface at any point thereon and a plurality of the indentations can be positioned thereon as previously described. The representation of the indentation 100 is a flat surface representation of the indentation. In most cases, the conduit to which the indentation is applied will be cylindrical and therefore the indentation will be applied to a curved surface and the edges of the indentation will be curved. In addition, other shapes of indentation may be used, for example a square or rectangular indentation can be applied to the fluid contacting the inner surface of the conduit. Also, the indentations may be angled towards or away from the direction of fluid flow in order to create turbulence.

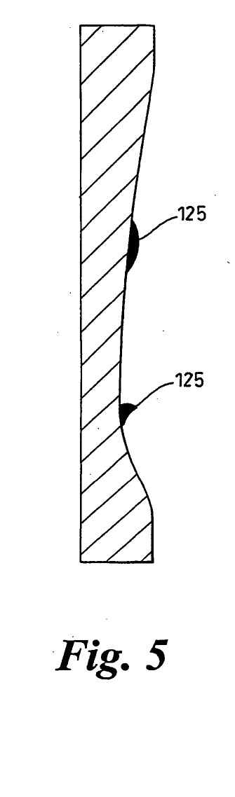

FIG. 5 shows a cross sectional view of an indentation 100 similar to that of FIGS. 4a, 4b and 4c. In addition this embodiment shows a pair of blades 125 extending from the surface of the indentation to assist in providing turbulent flow. The blades do not extend into the space enclosed by the normal surface shape of the inner surface of the cylinder and are provided in the indentation only.

In use, as fluids are transported through the connector, and come into contact with the profiles, the flow regime of these fluids is changed from laminar to turbulent. This change reduces the deposition of solids on the bore surface 40 and the bore surface of any pipes connected thereto as the speed of flow of the solids is increased and does not allow them to travel slowly enough to be deposited on the bore surface. As previously stated this would impact upon the economics of any transport system and effectively increase the period of time between remedial clean out operations.

The internal profile of the turbulence inducing means will change the flow regime of the fluid passing through it. The shape of the internal profile will vary to suit the fluid type, flow rate and solids encountered. The profile will not reduce the internal diameter at the pipe connection but will be machined as a repeated recess around the internal circumference, a number of times. Additionally, by the nature of the flow regimes induced, the means would be self-cleaning.

It should be noted at this stage that by the very nature of the connector means, there may be a part of the threaded portion left exposed, whether male or female. In this instance, it should be understood that the helical nature of this threaded portion is not to be construed as circumferentially discontinuous for the purposes of this invention.

The present invention may be suitable for use in a range of industries for example food processing, heat exchange, chemical production and sewerage treatment.

While certain modifications and variations have been described above, the invention is not restricted thereto, and other modifications and variations can be adopted without departing from the scope of the invention.

1. A conduit for use in the transportation of fluids, wherein said conduit is provided with at least one circumferentially discontinuous profiled turbulence inducing means formed in a fluid contacting inner surface of the conduit.

2. A conduit as claimed in claim 1 wherein the profiled turbulence inducing means are formed integrally with the fluid contacting inner surface of the conduit.

3. A conduit as claimed in claim 1 wherein the conduit is provided with a recess to accommodate an insert shaped to fit the inner diameter surface of the conduit and forming the fluid contacting inner surface of the conduit, said insert being provided with a plurality of circumferentially discontinuous profiled turbulence inducing means formed integrally therewith.

4. A conduit as claimed in claim 1 wherein the profiled turbulence inducing means are provided by at least one indentation.

5. A conduit as claimed in claim 1 wherein a plurality of indentations are arranged at a variety of angles to an axis of said conduit.

6. A conduit as claimed in claim 1 wherein the profiled turbulence inducing means are provided by at least one blade formed in the indentation.

7. A conduit as claimed in claim 1 wherein the profile is curved.

8. A conduit as claimed in claim 1 wherein the profiled turbulence inducing means is angular.

9. A conduit as claimed in claim 1 wherein the turbulence inducing means is arrange longitudinally along the conduit.

10. A conduit as claimed in claim 1 wherein the turbulence inducing means is arranged helically around the inner surface of the conduit.

11. A conduit as claimed in claim 1 wherein the turbulence inducing means is arranged randomly around the inner surface of the conduit.

12. A conduit as claimed in claim 1 wherein said conduit is a pipe connector.

13. A conduit as claimed in claim 1 wherein said conduit is a pin connector or a box connector.
